(19) United States
(12) Patent Application Publication
(10) Pub. No.: US 2026/0243050 A1
(43) Pub. Date: Aug. 20, 2026

(54) SYSTEM AND METHOD FOR CONTROLLING WORK MACHINE

(71) Applicant: KOMATSU LTD., Tokyo (JP)

(72) Inventors: Yuki SHIMANO, Tokyo (JP); Takuma NAKAMURA, Tokyo (JP); Yosuke UCHIDA, Tokyo (JP); Takashi YOKOO, Tokyo (JP)

(21) Appl. No.: 19/164,604

(22) PCT Filed: Feb. 16, 2024
(86) PCT No.: PCT/JP2024/005560

§ 371 Date: Sep. 12, 2025

(30) Foreign Application Priority Data
Jun. 30, 2023 (JP) 2023-108704

(51) Int. Cl. E02F 3/43; E02F 3/32; E02F 9/26

(52) U.S. Cl. CPC E02F 3/435; E02F 3/32; E02F 9/262

(57) ABSTRACT

A system controls a work machine including a revolving body revolvable around a revolving center and a work implement attached to the revolving body. The system includes a controller. The controller acquires a design line extending on a terrain on which construction is carried out. The controller determines a target line based on the design line. The controller executes revolving alignment control to cause the revolving of the revolving body to automatically stop when a work reference point included in the work implement reaches the target line during the revolving of the revolving body.

### CROSS-REFERENCE TO RELATED APPLICATIONS

This application is a U.S. National stage application of International Application No. PCT/JP2024/005560, filed on Feb. 16, 2024. This U.S. National stage application claims priority under 35 U.S.C. § 119(a) to Japanese Patent Application No. 2023-108704, filed in Japan on Jun. 30, 2023. The entire contents of Japanese Patent Application No. 2023-108704 is hereby incorporated herein by reference.

### BACKGROUND

### Technical Field

The present disclosure relates to a system and method for controlling a work machine.

### Background Art

Some work machines include a vehicle body and a work implement. The vehicle body includes a traveling body and a revolving body. The revolving body can revolve around a revolving center with respect to the traveling body. The work implement is operably attached to the revolving body. The work implement includes, for example, a bucket, and performs work such as excavation.

Such a work machine may perform work for digging a long linear trench. An operator of the work machine operates the work machine to excavate a terrain along a design line indicating a position where the trench is to be formed, thereby forming the trench. In this case, the operator first moves the work machine so that position of a predetermined reference point of the vehicle body and a predetermined reference point of the work implement are aligned with the design line. The operator excavates the terrain on the design line using the work implement. The operator revolves the revolving body and discharges the excavated soil to a position off the design line. The operator revolves the revolving body so that the position of the reference point of the work implement is aligned with the design line. The operator causes the work machine to move backward along the design line. When the excavating, soil discharging, revolving, and reverse moving are repeatedly performed, a long linear trench is constructed on the terrain.

In the work, it is required to precisely align the position of the reference point of the vehicle body and the position of the reference point of the work implement with the design line. As a technology for supporting such alignment, for example, PCT Publication No. WO 2017/010563 discloses a display system that displays a screen showing a reference point of a vehicle body, a reference point of a work implement, and a design line on a display.

### SUMMARY

With the above-described technology, it is possible for the operator to easily ascertain a positional relationship between the reference point of the vehicle body, the reference point of the work implement, and the design line through the screen displayed on the display. However, in order to align the position of the reference point of the work implement with the design line, the revolving body needs to be precisely operated each time the revolving body is caused to revolve, which places a heavy burden on the operator. An object of the present disclosure is to facilitate a revolving operation for aligning a work implement in a work machine.

An aspect of the present disclosure is a system for controlling a work machine. A work machine includes a revolving body and a work implement. The revolving body can revolve around a revolving center. The work implement is attached to the revolving body. The system includes a controller. The controller acquires a design line that extends on a terrain to be constructed. The controller determines the target line based on the design line. The controller executes revolving alignment control for causing the revolving of the revolving body to automatically stop when the work reference point included in the work implement reaches a target line during revolving of the revolving body.

Another aspect of the present disclosure is a method for controlling a work machine. A work machine includes a revolving body and a work implement. The revolving body can revolve around a revolving center. The work implement is attached to the revolving body. The method includes acquiring a design line extending on a terrain on which construction is carried out; determining a target line based on the design line; and executing revolving alignment control for causing the revolving of the revolving body to automatically stop when a work reference point included in the work implement reaches the target line during the revolving of the revolving body.

According to the present disclosure, the revolving alignment control automatically stops the revolving of the revolving body when a work reference point reaches a target line during revolving of the revolving body. This makes it easier to perform the revolving operation for aligning the work implement.

### BRIEF DESCRIPTION OF DRAWINGS

Referring now to the attached drawings which form a part of this original disclosure, an illustrative embodiment is shown.

FIG. 1 is a side view of a work machine.

FIG. 2 is a block diagram illustrating a configuration of a work machine and a control system thereof.

FIG. 3 is a flowchart showing a process of travel alignment control.

FIG. 4 is a diagram illustrating an example of a guide screen.

FIG. 5 is an enlarged view of an icon showing a work machine displayed on a guide screen.

FIG. 6 is a diagram illustrating an example of a guide screen in the travel alignment control.

FIG. 7 is a diagram illustrating an example of a guide screen showing a control execution area.

FIG. 8 is a diagram illustrating an example of a guide screen in a state where a travel reference point is aligned with a target line.

FIG. 9 is a diagram illustrating an example of a guide screen while automatic steering is stopped.

FIG. 10 is a flowchart showing processing of revolving alignment control.

FIG. 11 is a diagram illustrating an example of a guide screen in the revolving alignment control.

FIG. 12 is a diagram illustrating an example of a guide screen in a state where a work reference point is aligned with a target line.

FIG. 13 is a diagram illustrating an example of a guide screen showing a control stop area.

### DETAILED DESCRIPTION OF EMBODIMENT(S)

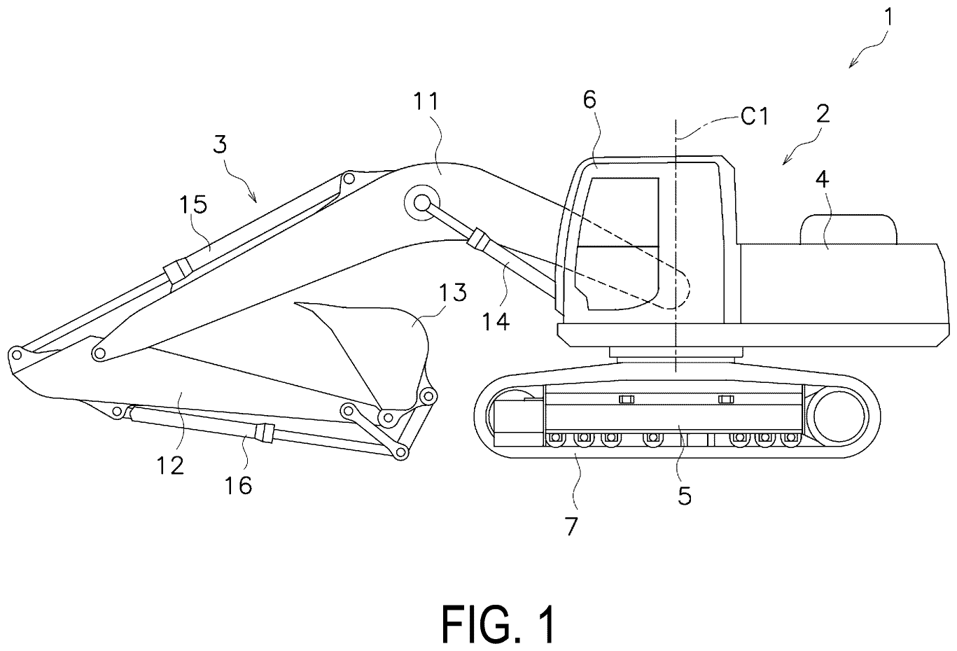

Hereinafter, a work machine according to an embodiment will be described with reference to the drawings. FIG. 1 is a side view of a work machine 1. In the present embodiment, the work machine 1 is an excavator such as a hydraulic excavator or an electric excavator.

As illustrated in FIG. 1, the work machine 1 includes a vehicle body 2 and a work implement 3. The vehicle body 2 includes a revolving body 4 and a traveling body 5. The work implement 3 is attached to the revolving body 4. The revolving body 4 is revolvably connected to the traveling body 5. The revolving body 4 can revolve around a revolving center C1. A cab 6 is disposed on the revolving body 4. The traveling body 5 includes a track 7. In FIG. 1, only one of left and right tracks 7 is illustrated. The work machine 1 travels when the track 7 is driven.

The work implement 3 is attached to the revolving body 4 to be able to operate up and down. The work implement 3 includes a boom 11, an arm 12, and a bucket 13. The boom 11 is rotatably attached to the revolving body 4. The arm 12 is rotatably attached to the boom 11. The bucket 13 is rotatably attached to the arm 12.

The work implement 3 includes a boom cylinder 14, an arm cylinder 15, and a bucket cylinder 16. The boom cylinder 14, the arm cylinder 15, and the bucket cylinder 16 are, for example, hydraulic cylinders. The boom cylinder 14 operates the boom 11. The arm cylinder 15 operates the arm 12. The bucket cylinder 16 operates the bucket 13.

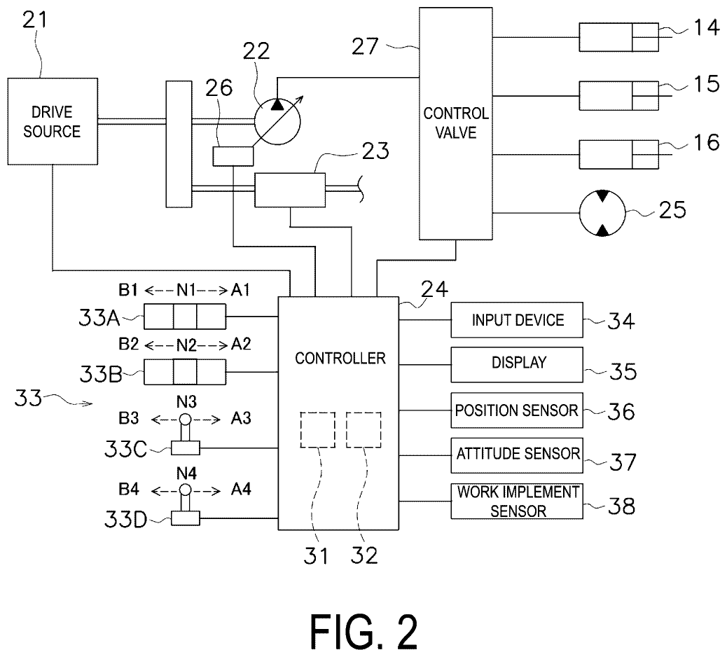

FIG. 2 is a block diagram illustrating a configuration of the work machine 1 and a control system thereof. As illustrated in FIG. 2, the work machine 1 includes a drive source 21, a hydraulic pump 22, a power transmission device 23, and a controller 24. The drive source 21 is controlled according to a command signal from the controller 24. The drive source 21 is, for example, an internal combustion engine. Alternatively, the drive source 21 may include a drive source such as an electric motor or a hydrogen engine. The hydraulic pump 22 is driven by the drive source 21 to discharge hydraulic oil. The hydraulic oil discharged from the hydraulic pump 22 is supplied to the boom cylinder 14, the arm cylinder 15, and the bucket cylinder 16.

The work machine 1 includes a revolving motor 25. The revolving motor 25 is, for example, a hydraulic motor. The revolving motor 25 is driven by the hydraulic oil from the hydraulic pump 22. Alternatively, the revolving motor 25 may be an electric motor. The revolving motor 25 revolves the revolving body 4. Although one hydraulic pump is illustrated in FIG. 2, a plurality of hydraulic pumps may be provided.

The hydraulic pump 22 is a variable displacement pump. A pump control device 26 is connected to the hydraulic pump 22. The pump control device 26 controls a tilt angle of the hydraulic pump 22. The pump control device 26 includes, for example, an electromagnetic valve, and is controlled according to a command signal from the controller 24. The controller 24 controls the pump control device 26 to control a displacement of the hydraulic pump 22.

The work machine 1 includes a control valve 27. The hydraulic pump 22, the cylinders 14 to 16, and the revolving motor 25 are connected by a hydraulic circuit via the control valve 27. The control valve 27 is controlled according to a command signal from the controller 24. The control valve 27 controls a flow rate of hydraulic oil supplied from the hydraulic pump 22 to the cylinders 14 to 16 and the revolving motor 25. The controller 24 controls an operation of the work implement 3 by controlling the control valve 27. The controller 24 controls the revolving of the revolving body 4 by controlling the control valve 27. The cylinders 14 to 16 are not limited to hydraulic cylinders, and may be mechanical cylinders driven by an electric motor.

The power transmission device 23 transmits a driving force of the drive source 21 to the traveling body 5. The track 7 is driven by the driving force from the power transmission device 23 to cause the work machine 1 to travel. The power transmission device 23 may be, for example, a transmission having a torque converter or a plurality of speed change gears.

Alternatively, the power transmission device 23 may be another type of transmission such as Hydro Static Transmission (HST) or Hydraulic Mechanical Transmission (HMT).

The controller 24 includes a processor 31 such as a CPU, and a storage device 32. The processor 31 performs processing for controlling the work machine 1. The storage device 32 includes a memory such as a RAM or a ROM, and an auxiliary storage device such as a Hard Disk Drive (HDD) or a Solid State Drive (SSD). The storage device 32 stores data and programs for controlling the work machine 1.

The control system includes an operation device 33, an input device 34, and a display 35. The operation device 33, the input device 34, and the display 35 are arranged in the cab 6. The operation device 33 can be operated by the operator. The operation device 33 includes a travel operation device 33A, a steering operation device 33B, a revolving operation device 33C, and a work implement operation device 33D.

The travel operation device 33A can be operated by the operator to manually operate the forward and reverse travel of the work machine 1. The travel operation device 33A includes, for example, a switch. However, the travel operation device 33A may include other members such as a lever. The travel operation device 33A can be operated from the neutral position N1 in a forward direction Al and a reverse direction B1. The travel operation device 33A outputs an operation signal in accordance with the operation of the operator to the controller 24.

The steering operation device 33B can be operated by the operator to manually operate the steering of the work machine 1. The steering operation device 33B includes, for example, a switch. However, the steering operation device 33B may include other members such as a lever. The steering operation device 33B can be operated from the neutral position N2 in a right steering direction A2 and a left steering direction B2. The steering operation device 33B outputs an operation signal in accordance with the operation of the operator to the controller 24.

The revolving operation device 33C can be operated by the operator to manually revolving the revolving body 4. The revolving operation device 33C includes, for example, a lever. However, the revolving operation device 33C may include other members such as a switch. The revolving operation device 33C can be operated in a right revolving direction A3 and a left revolving direction B3 from a neutral position N3. The revolving operation device 33C outputs an operation signal in accordance with the operation of the operator to the controller 24.

The work implement operation device 33D can be operated by the operator to manually operate the work implement 3. The work implement operation device 33D includes, for example, a lever. However, the work implement operation device 33D may include other members such as a switch. For example, the work implement operation device 33D can be operated in an up direction A4 and a down direction B4 from a neutral position N4. The revolving operation device 33C outputs an operation signal in accordance with the operation of the operator to the controller 24. Each of the operation devices 33A to 33D may be configured of a common member.

The controller 24 controls the drive source 21 and the power transmission device 23 so that the work machine 1 travels, in response to the operation of the travel operation device 33A by the operator. Accordingly, the work machine 1 moves forward or backward in response to the operation of the travel operation device 33A. The controller 24 controls the drive source 21 and the power transmission device 23 to steer the work machine 1 to the left or right in response to the operation of the steering operation device 33B by the operator. For example, the controller 24 steers the work machine 1 to the left or right due to a speed difference between the left and right tracks 7. Accordingly, the work machine 1 is steered to the left or right in response to the operation of the travel operation device 33A.

The controller 24 controls the control valve 27 so that the revolving body 4 is revolved relative to the traveling body 5 in response to an operation of the revolving operation device 33C by the operator. Accordingly, the revolving body 4 revolves clockwise or counterclockwise in response to the operation of the revolving operation device 33C. The controller 24 controls the control valve 27 so that the work implement 3 operates, in response to the operation of the work implement operation device 33D by the operator. Accordingly, the work implement 3 operates up and down in response to the operation of the work implement operation device 33D.

The input device 34 can be operated by the operator. The input device 34 is a touch screen. However, the input device 34 may include hardware keys. The operator inputs various settings related to the work machine 1 by operating the input device 34. The input device 34 outputs an input signal in response to the operation of the operator. The display 35 is, for example, an LCD, an OELD, or another type of display. The display 35 displays a screen in accordance with a display signal from the controller 24.

The control system includes a position sensor 36, an attitude sensor 37, and a work implement sensor 38. The position sensor 36 detects a position and orientation of the work machine 1. The position sensor 36 includes, for example, a sensor based on a Global Navigation Satellite System (GNSS). Specifically, the position sensor 36 detects the position and orientation of the revolving body 4. The position sensor 36 outputs position data indicating the position and orientation of the revolving body 4.

The attitude sensor 37 is attached to the revolving body 4. The attitude sensor 37 detects the attitude of the revolving body 4. The attitude of the revolving body 4 includes, for example, a yaw angle, pitch angle, and roll angle of the revolving body 4. The attitude sensor 37 is, for example, an Inertial Measurement Unit (IMU). The attitude sensor 37 outputs first attitude data indicating the attitude of the revolving body 4.

The work implement sensor 38 detects an attitude of the work implement 3. The attitude of the work implement 3 includes a boom angle, an arm angle, and a bucket angle. The boom angle is an angle of the boom 11 relative to the revolving body 4. The arm angle is an angle of the arm 12 relative to the boom 11. The bucket angle is the angle of the bucket 13 relative to the arm 12. The work implement sensor 38 outputs second attitude data indicating the boom angle, the arm angle, and the bucket angle. The work implement sensor 38 may detect, for example, a stroke length of each of the cylinders 14 to 16, and the controller 24 may calculate the boom angle, the arm angle, and the bucket angle from the stroke length of each of the cylinders 14 to 16. Alternatively, the work implement sensor 38 may be an angle sensor that directly detects the boom angle, the arm angle, and the bucket angle.

The controller 24 receives the operation signal from the operation device 33. The controller 24 receives an input signal from the input device 34. The controller 24 outputs a display signal to the display 35. The controller 24 receives the position data from the position sensor 36. The controller 24 receives the first attitude data from the attitude sensor 37. The controller 24 receives the second attitude data from the work implement sensor 38.

The controller 24 calculates a position and orientation of a predetermined part of the work machine 1 from the position data, the first attitude data, and the second attitude data. For example, the controller 24 calculates the position and orientation of the traveling body 5 and the position and orientation of the revolving body 4 based on the position data and the first attitude data. The controller 24 calculates a position and orientation of the work implement 3 based on the position data, the first attitude data, and the second attitude data. The position and orientation of the work implement 3 may be directly detected by a position sensor attached to the work implement 3. The position of the work machine 1 is indicated by plane coordinates and altitude at the work site. The orientation of the work machine 1 is indicated by orientation coordinates of east, west, north, and south.

Next, the automatic control of the work machine 1 will be described. The controller 24 executes the automatic control of the work machine 1 based on the position and orientation of the work machine 1. In the present embodiment, the work machine 1 performs the work of forming a long trench at the work site by excavating the terrain along a design line extending on the terrain to be constructed. In this case, the automatic control assists the manual operation by the operator. The design line is set, for example, based on a construction plan. Alternatively, the design line may be set based on a survey of the terrain at the work site.

The automatic control includes travel alignment control and revolving alignment control. In the travel alignment control, the controller 24 automatically controls the steering of the work machine 1 so that the travel direction of the work machine 1 is aligned with a direction in which the design line extends, when the work machine 1 travels. In the revolving alignment control, the controller 24 automatically stops the revolving body 4 so that the bucket 13 is aligned with a position of the design line during excavation work of the work machine 1. The operator can set the travel alignment control and the revolving alignment control to be enabled or disabled by operating the input device 34.

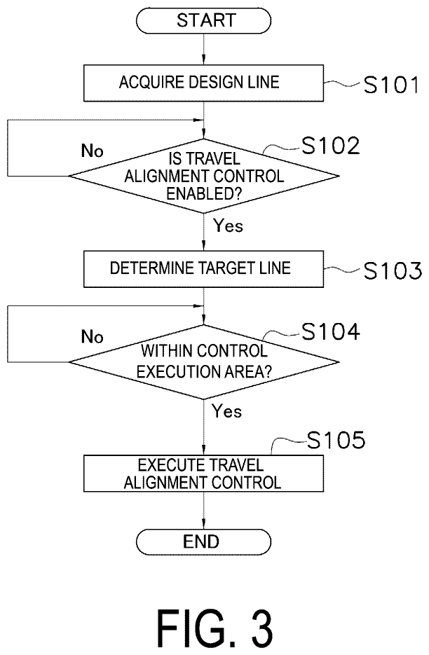

FIG. 3 is a flowchart showing a process of the travel alignment control. As illustrated in FIG. 3, in step S101, the controller 24 acquires the design line. The position of the design line is stored in the storage device 32. For example, the controller 24 acquires data indicating the position of the design line from an external computer. Alternatively, the controller 24 may acquire the position of the design line via the input device 34.

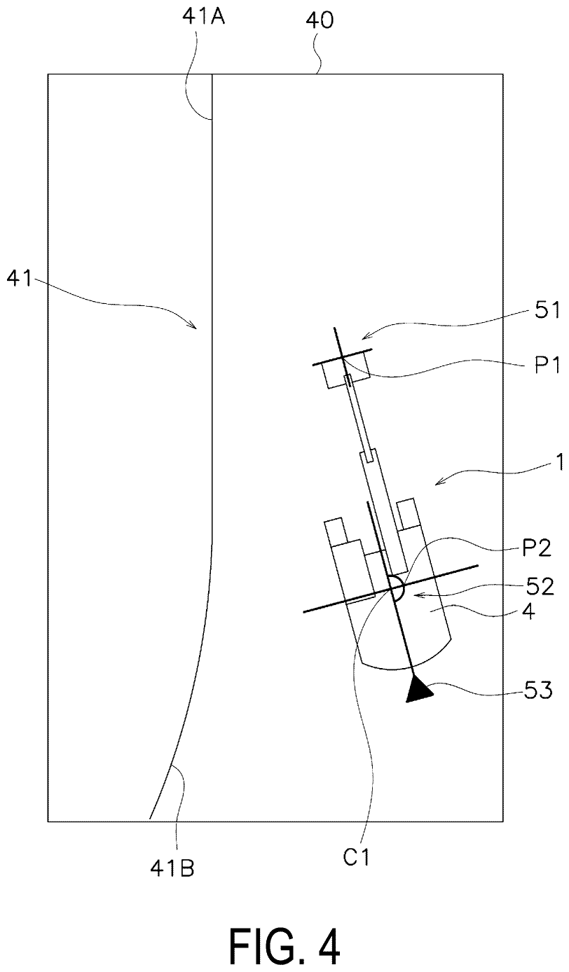

As illustrated in FIG. 4, the controller 24 displays a guide screen 40 indicating a positional relationship between the design line 41 and the work machine 1 on the display 35. The guide screen 40 indicates the work machine 1 and the design line 41 in a top view. The work machine 1 is shown by an icon having a shape of the work machine 1 in a top view. The controller 24 displays the work machine 1 and the design line 41 on the guide screen 40 according to an actual position and orientation of the work machine 1.

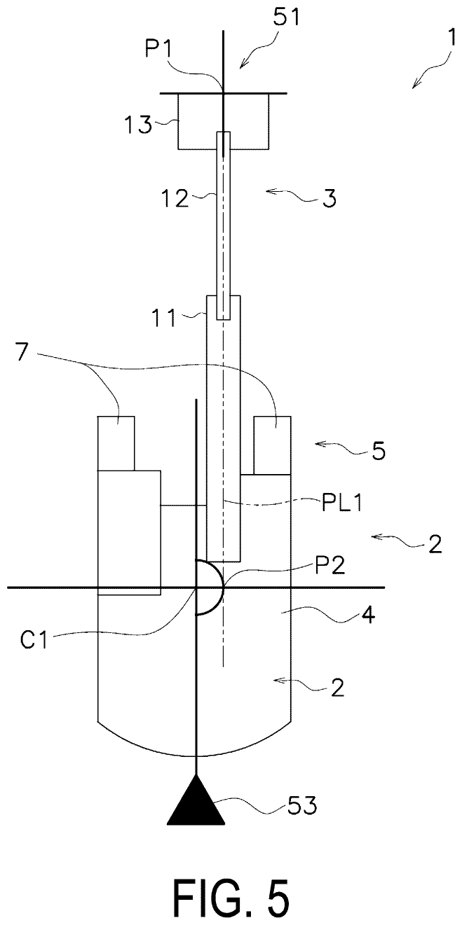

The guide screen 40 also includes assistance images 51 to 53. The assistance images 51 to 53 indicate a position or orientation of a specific part of the work machine 1. FIG. 5 is an enlarged view of the icon indicating the work machine 1 and the assistance images 51 to 53. As illustrated in FIG. 5, the assistance image includes a work assistance image 51, a travel assistance image 52, and an orientation assistance image 53.

The work assistance image 51 indicates a position of a work reference point P1 included in the work implement 3. The work reference point P1 is, for example, a center in a left-right direction of a blade tip of the bucket 13. Alternatively, the work reference point P1 may be a left end or a right end of the blade tip of the bucket 13. The work reference point P1 may be selectable from the left end, center, or right end of the bucket 13 by the input device 34. The work assistance image 51 has a crosshair shape. An intersection of the crosshair on the work assistance image 51 indicates the position of the work reference point P1.

The travel assistance image 52 indicates positions of the revolving center C1, and the travel reference point P2 included in the vehicle body 2. The travel assistance image 52 has a shape that is a combination of a crosshair with an arc. An intersection of the crosshair on the travel assistance image 52 indicates the position of the revolving center C1. The travel reference point P2 is a position offset from the revolving center C1 in a left-right direction of the traveling body 5. An apex of the arc of the crosshair of the travel assistance image 52 indicates the travel reference point P2.

The travel reference point P2 is indicated by a tangent point between a work implement plane PL1 and an arc centered on the revolving center C1. The work implement plane PL1 is a plane including a trajectory of the work reference point P1 when the work implement 3 operates up and down. In a state in which the work implement 3 is disposed along a front-rear direction of the traveling body 5 in a top view of the work machine 1, the work implement plane PL1 is indicated by a straight line passing through the work reference point P1 and extending in the front-rear direction of the work machine 1.

The orientation assistance image 53 indicates the orientation of the traveling body 5. The orientation assistance image 53 indicates a direction of the track 7. The orientation assistance image 53 is indicated, for example, by a triangular shape.

In step S102, the controller 24 determines whether the travel alignment control is enabled. For example, when the operator touches the design line 41 on the guide screen 40 in a state in which the travel alignment control is set to ON, the controller 24 determines that the travel alignment control is enabled. The ON and OFF of the travel alignment control is set, for example, by the input device 34. When the travel alignment control is enabled, the process proceeds to step S103.

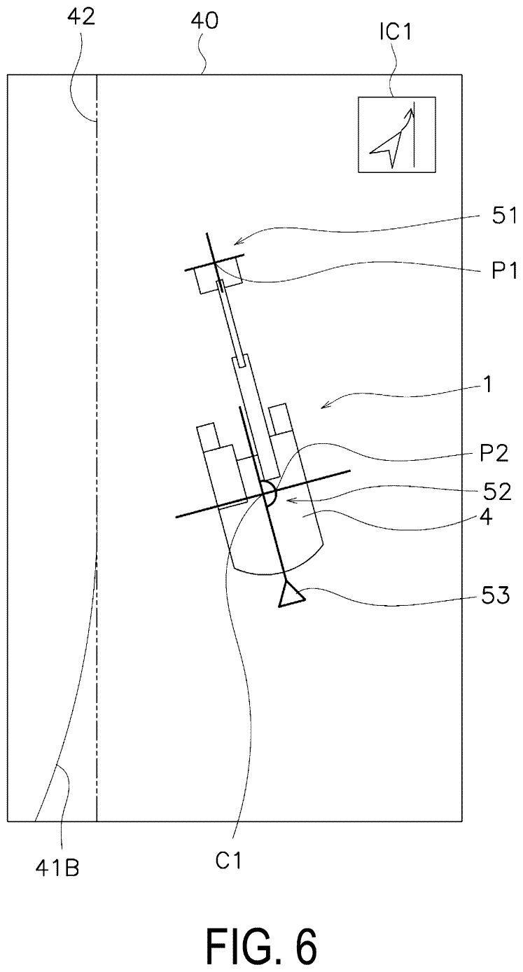

In step S103, the controller 24 determines the target line 42. The controller 24 determines a line obtained by linearly extending the design line 41 as the target line 42. As illustrated in FIG. 6, the controller 24 displays the target line 42 on the guide screen 40. When the design line 41 includes a straight portion 41A and a curved portion 41B and the straight portion 41A is touched, the controller 24 determines a line extending from the straight portion 41A as the target line 42.

As illustrated in FIG. 6, the controller 24 displays the target line 42 on the guide screen 40 in a different aspect from the design line 41 illustrated in FIG. 4. For example, the controller 24 displays the target line 42 on the guide screen 40 in a color different from that of the design line 41. Further, the controller 24 displays a control icon IC1 indicating that the travel alignment control has started on the guide screen 40. The operator operates the travel operation device 33A to move the work machine 1 forward or backward so that the work machine 1 approaches the target line 42.

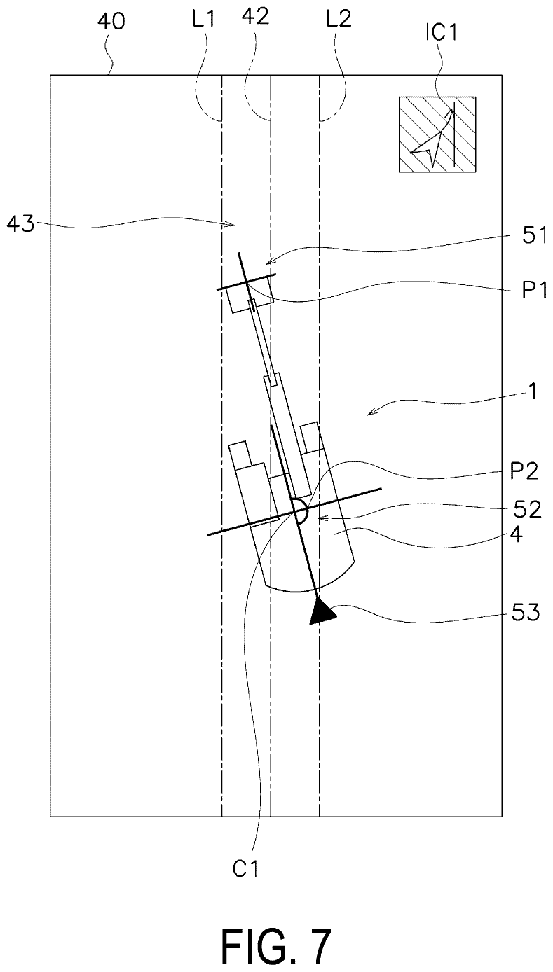

In step S104, the controller 24 determines whether the travel reference point P2 is located within a control execution area 43. The control execution area 43 is an area up to a position separated by an allowable width from the target line 42 in both directions to the left and right of the target line 42. The allowable width can be set, for example, by the input device 34. When the travel reference point P2 is located within the control execution area 43, the controller 24 displays the control execution area 43 on the guide screen 40 as illustrated in FIG. 7. The control execution area 43 is away in both directions to the left and right from the target line 42, and is indicated by two straight lines L1 and L2 extending in a direction parallel to the target line 42.

When the travel reference point P2 is located outside the control execution area 43, the controller 24 does not perform automatic steering, but steers the work machine 1 according to a manual operation using the steering operation device 33B. Further, as illustrated in FIG. 6, when the travel reference point P2 is located outside the control execution area 43, the controller 24 does not display the control execution area 43 on the guide screen 40.

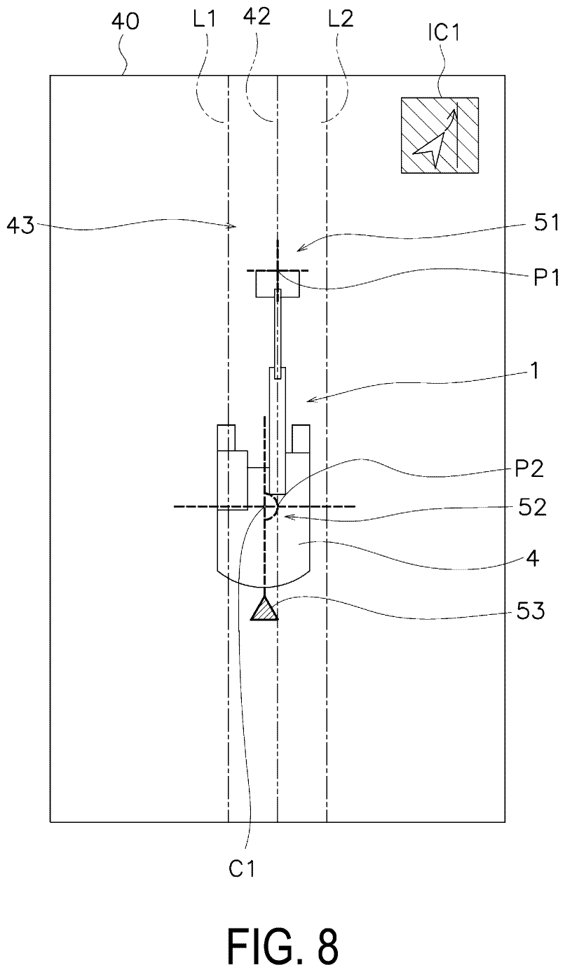

When the travel reference point P2 is located within the control execution area 43, the process proceeds to step S105. In step S105, the controller 24 performs travel alignment control. As illustrated in FIGS. 7 and 8, the controller 24 automatically steers the work machine 1 so that the travel reference point P2 follows the target line 42 while the work machine 1 is traveling. That is, the controller 24 automatically steers the work machine 1 so that the arc of the travel assistance image 52 is tangent to the target line 42 at the travel reference point P2. Accordingly, the controller 24 travels the work machine 1 in response to a manual operation using the travel operation device 33A, and automatically steers the work machine 1 so that the travel reference point P2 follows the target line 42.

As illustrated in FIG. 8, when the travel reference point P2 is aligned with the target line 42, the controller 24 displays the travel assistance image 52 in a different aspect from when the travel reference point P2 is not aligned with the target line 42.

Even when the travel reference point P2 is located within the control execution area 43, when the manual operation using the steering operation device 33B is performed, the controller 24 prioritizes the manual operation using the steering operation device 33B over the travel alignment control. That is, even when the travel reference point P2 is located within the control execution area 43, when the manual operation is performed by the steering operation device 33B, the controller 24 stops the travel alignment control and steers the work machine 1 according to the manual operation using the steering operation device 33B.

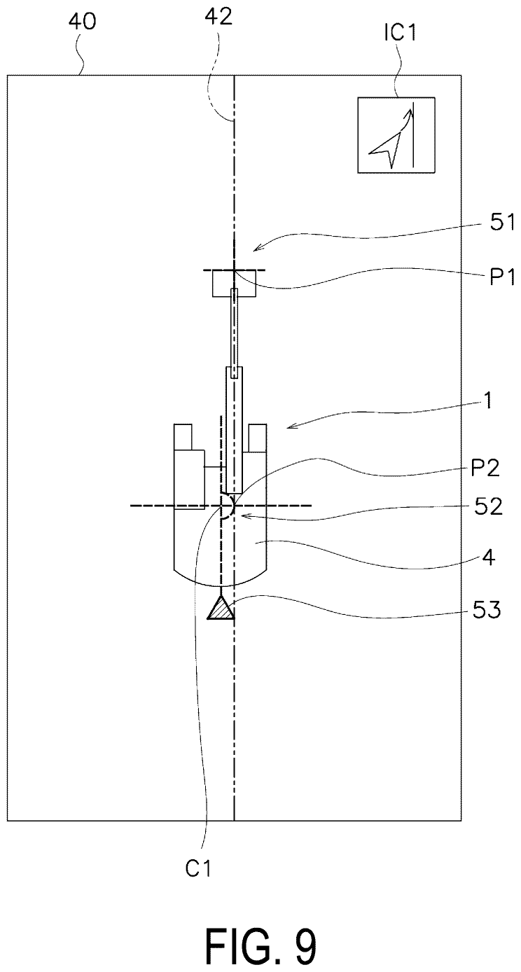

As illustrated in FIGS. 7 and 8, the controller 24 displays the control icon IC1 in a different aspect from that during stopping of the travel alignment control, during execution of the travel alignment control. For example, the controller 24 displays the control icon IC1 in a different color from that during stopping of the travel alignment control, during execution of the travel alignment control. As illustrated in FIG. 9, even when the travel reference point P2 is located within the control execution area 43, the controller 24 does not display the control execution area 43 on the display 35 during stopping of the travel alignment control. Further, even when the operator is not operating the travel operation device 33A and the travel of the work machine 1 is stopped, the controller 24 displays the control icon IC1 in the same manner as that during stopping of the travel alignment control.

When the travel operation using the travel operation device 33A ends, the controller 24 stops the travel alignment control. However, since the travel alignment control is in an enabled state, the controller 24 continues to execute the travel alignment control when the travel operation using the travel operation device 33A is resumed.

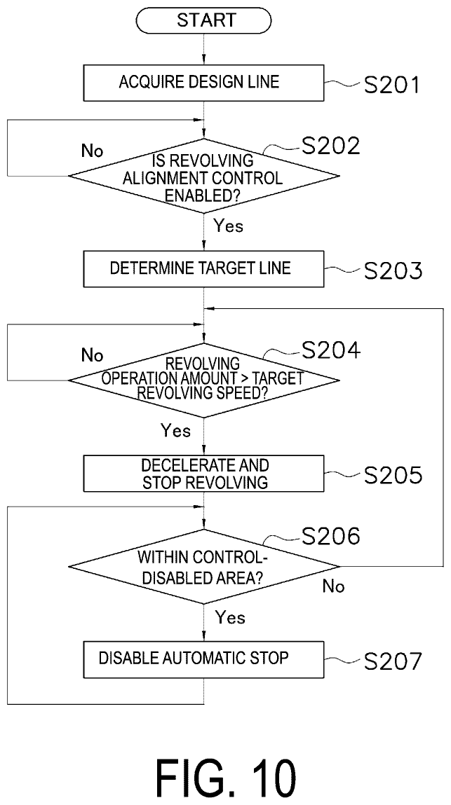

Next, the revolving alignment control will be described. FIG. 10 is a flowchart showing processing of the revolving alignment control. As illustrated in FIG. 10, in step S201, the controller 24 acquires the design line 41. The controller 24 acquires the design line 41 in the same manner as the travel alignment control described above.

In step S202, the controller 24 determines whether the revolving alignment control is enabled. For example, in a state in which the revolving alignment control is set to ON and when the operator touches the design line 41 on the guide screen 40, the controller 24 determines that the revolving alignment control is enabled. The revolving alignment control is set to ON/OFF by, for example, the input device 34. When the revolving alignment control is enabled, the process proceeds to step S203.

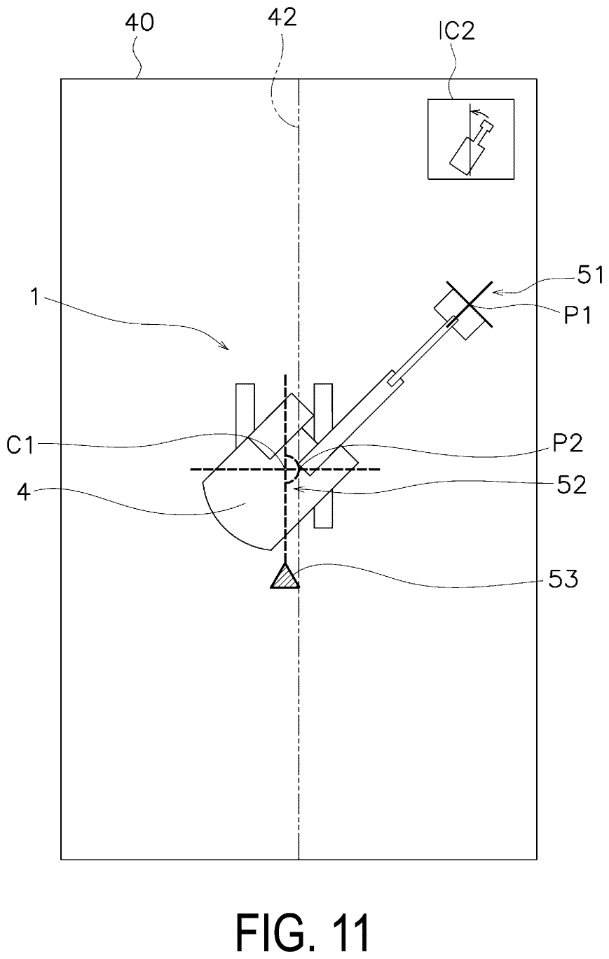

In step S203, the controller 24 determines the target line 42. The controller 24 determines the target line 42 as in the process of the travel alignment control. FIG. 11 is a diagram illustrating the guide screen 40 during the revolving alignment control. As in the travel alignment control, the controller 24 displays the target line 42 on the guide screen 40 in a different aspect from the design line 41. For example, the controller 24 displays the target line 42 on the guide screen 40 in a color different from that of the design line 41. Further, the controller 24 displays a control icon IC2 indicating that the revolving alignment control has started on the guide screen 40.

After the target line 42 is determined, the operator operates the revolving operation device 33C to revolve the revolving body 4. In FIG. 11, the work reference point P1 is located at a position away the target line 42, such as a soil discharge position. The operator operates the revolving operation device 33C to revolve the revolving body 4 so that the work reference point P1 approaches the target line 42.

In step S204, the controller 24 determines whether a revolving operation amount of the revolving body 4 is larger than a target revolving speed. The target revolving speed is set based on the revolving angle from the actual revolving position to the target line 42. When the revolving speed in accordance with the operation of the revolving operation device 33C of the revolving body 4 is larger than the target revolving speed, the controller 24 determines that the revolving operation amount of the revolving body 4 is larger than the target revolving speed. When the revolving operation amount of the revolving body 4 is larger than the target revolving speed, the process proceeds to step S205.

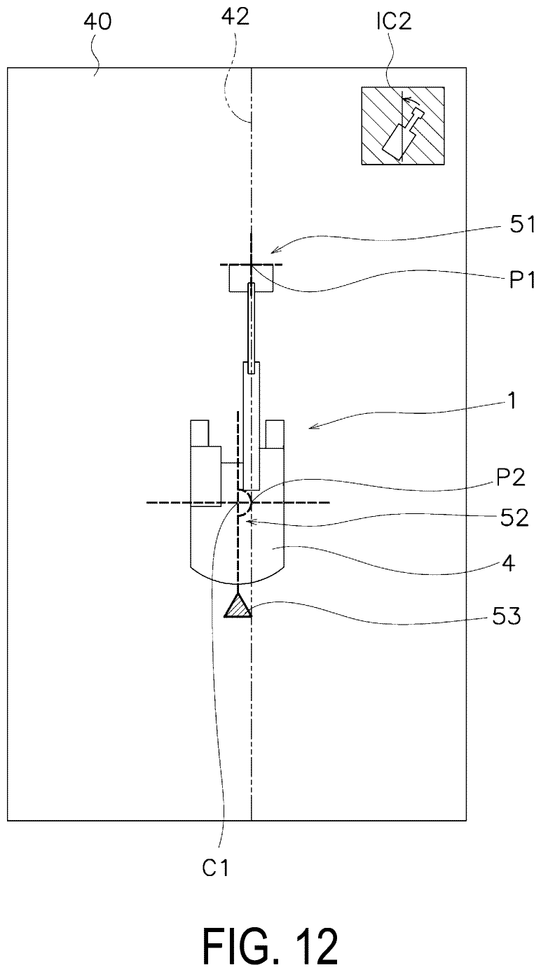

In step S205, the controller 24 decelerates the revolving body 4. The controller 24 decelerates the revolving body 4 until the work reference point P1 reaches the target line 42, and automatically stops the revolving of the revolving body 4 when the work reference point P1 reaches the target line 42. Accordingly, as illustrated in FIG. 12, the revolving body 4 stops in a state in which the work reference point P1 is aligned with the target line 42. In this state, the operator can excavate the terrain on the target line 42 by operating the work implement operation device 33D. In step S204, when the revolving operation amount of the revolving body 4 is equal to or less than the target revolving speed, the revolving body 4 does not decelerate or automatically stop, but continues to revolve in response to the operation of the revolving operation device 33C.

In a state in which the work reference point P1 is aligned with the target line 42, the controller 24 displays the work assistance image 51 in a different aspect from that in the state in which the work reference point P1 deviates from the target line 42. For example, in a state in which the work reference point P1 is aligned with the target line 42, the controller 24 displays the work assistance image 51 in a different color than that in a state in which the work reference point P1 deviates from the target line 42.

Further, during the automatic stop of the revolving body 4, the controller 24 displays a control icon IC2 in a different aspect than when the revolving body 4 does not automatically stop. For example, during the automatic stop of the revolving body 4, the controller 24 displays the control icon IC2 in a different color than when the revolving body 4 does not automatically stop.

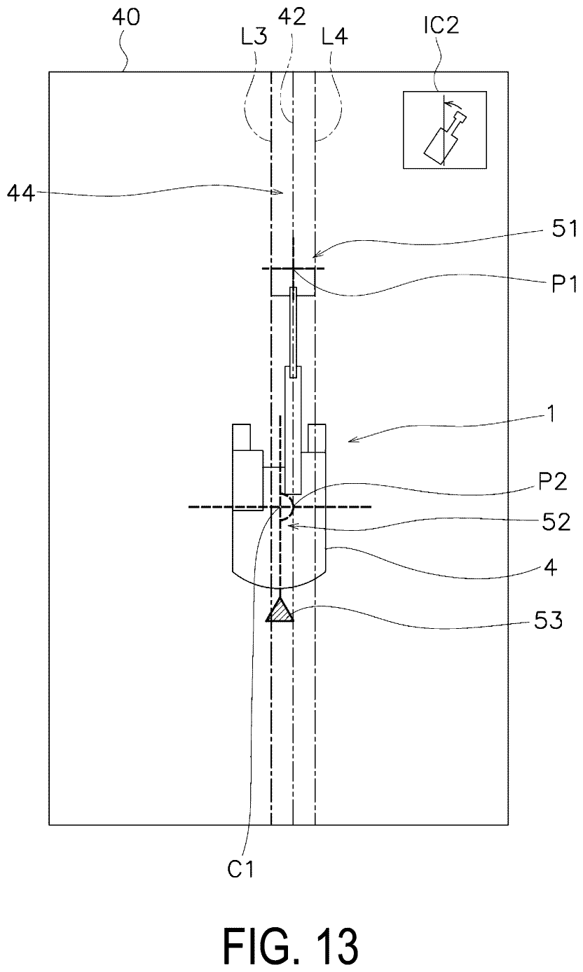

When the operator returns the revolving operation device 33C to the neutral position after the automatic stop of the revolving body 4, the controller 24 displays a control-disabled area 44 on the guide screen 40, as illustrated in FIG. 13. The control-disabled area 44 is an area from the target line 42 to the position separated by the allowable width in both directions to the left and right of the target line 42. The allowable width can be set, for example, by the input device 34. The control-disabled area 44 is separated in the left and right directions from the target line 42, and is indicated by two straight lines L3 and L4 extending in a direction parallel to the target line 42. Further, after the operator returns the revolving operation device 33C to the neutral position, the controller 24 revolves the revolving body 4 in response to the operation of the revolving operation device 33C.

In step S206, the controller 24 determines whether the work reference point P1 is located within the control-disabled area 44. When the work reference point P1 is located within the control-disabled area 44, the controller 24 disables the automatic stop of the revolving body 4 in step S207. That is, even when the operator revolves the revolving body 4 through a manual operation after the automatic stop of the revolving body 4 and the work reference point Pl reaches the target line 42, the controller 24 does not automatically stop the revolving body 4 if the work reference point P1 is located within the control-disabled area 44. Accordingly, the operator can easily excavate the terrain near the target line 42 by manually revolving the work reference point P1 within the control-disabled area 44.

When the operator revolves the revolving body 4 through a manual operation so that the work reference point P1 moves out of the control-disabled area 44, the controller 24 erases the control-disabled area 44 from the guide screen 40 as illustrated in FIG. 11. For example, after the operator excavates the terrain on the target line 42 using the work implement 3, the operator revolves the revolving body 4 to discharge soil from the bucket 13 to a position away the target line 42. This erases the control-disabled area 44 from the guide screen 40.

Further, when the work reference point P1 goes outside the control-disabled area 44, the controller 24 re-enables the automatic stop of the revolving body 4. Accordingly, as described above, when the revolving speed of the revolving body 4 is smaller than the revolving operation, the revolving of the revolving body 4 is decelerated, and when the work reference point P1 reaches the target line 42, the controller 24 automatically stops the revolving body 4. When such operations of the work machine 1 are repeated, a trench is formed in the terrain on the target line 42.

Next, the operator causes the work machine 1 to move backward. In this case, the work machine 1 is automatically steered so that the travel reference point P2 moves along the target line 42, under the travel alignment control described above. The excavation and soil discharge are repeated again through the revolving of the revolving body 4 so that the trench is formed in the terrain on the target line 42. Such operations of the work machine 1 are repeated so that a long trench is formed in the terrain along the target line 42.

Similar to the travel alignment control, the revolving alignment control may also be ended when a control end operation is performed in the revolving alignment control.

In the work machine 1 according to the present embodiment described above, when the work reference point P1 reaches the target line 42 during the revolving of the revolving body 4, the revolving of the revolving body 4 is automatically stopped through the revolving alignment control. This makes it easier to perform the revolving operation for aligning the work implement 3.

The embodiment of the present invention has been described above, but the present invention is not limited to the embodiment, and various variations can be made without departing from the gist of the invention.

The work machine 1 may include wheels instead of the track 7. The work machine 1 may be remotely operable. The operation device 33, the input device 34, and the display 35 may be disposed outside the work machine 1. A part of the above-described automatic control process may be executed by a controller external to the work machine 1. The automatic control process may be distributed and executed by a plurality of controllers.

The work of the work machine 1 under automatic control is not limited to the work of forming the trench, but may be other work. For example, the automatic control may be applied to work of filling the trench with soil. The automatic control process is not limited to that of the embodiment, but may be changed. For example, the start of the travel alignment control or the revolving alignment control is not limited to touching the design line 41, but may be other operations. The travel alignment control may be omitted.

The guide screen 40 is not limited to that of the above embodiment, but may be changed. For example, the work assistance image 51 is not limited to the crosshair, but may have another shape such as a point. The travel assistance image 52 is not limited to the crosshair and the arc, but may have another shape such as a point. The orientation assistance image 53 is not limited to the triangle, and may have another shape such as an arrow. The “different aspect” in the display of the guide screen 40 described above is not limited to the different color, and may be a different shape. A shape of the control-disabled area 44 is not limited to that of the above embodiment, and may be changed. For example, the control-disabled area 44 may have a trapezoid or a sector shape.

### Supplement 1

A system for controlling a work machine including a revolving body revolvable around a revolving center and a work implement attached to the revolving body, the system including a controller,
in which the controller
acquires a design line extending on a terrain on which construction is carried out;
determines a target line based on the design line; and
executes revolving alignment control for causing the revolving of the revolving body to automatically stop when a work reference point included in the work implement reaches the target line during the revolving of the revolving body.

### Supplement 2

The system according to supplement 1, further including a display,
wherein the controller causes the work machine, the target line, and the work reference point to be displayed on the display.

### Supplement 3

The system according to supplement 1 or 2, further including an operation device operable by an operator to manually operate revolving of the revolving body,
in which the controller causes the revolving body to revolve in response to a manual operation of the operation device and causes revolving of the revolving body to automatically stop when the work reference point reaches the target line.

### Supplement 4

The system according to supplement 3, in which the controller causes the revolving body to revolve in response to a manual operation of the operation device after causing the revolving of the revolving body to automatically stop through the revolving alignment control, and disables the automatic stop of the revolving body when the work reference point is located within a predetermined region.

### Supplement 5

The system according to supplement 4, in which the predetermined region is a range up to a position separated by an allowable width from the target line.

### Supplement 6

The system according to supplement 4 or 5, further including a display,
in which the controller causes the work machine, the target line, the work reference point, and the predetermined region to be displayed on the display.

### Supplement 7

The system according to supplement 6, in which the controller
causes the predetermined region to be displayed on the display when the work reference point is located within the predetermined region after causing the revolving of the revolving body to automatically stop through the revolving alignment control, and
erases the predetermined region from the display when the work reference point is outside the predetermined region.

### Supplement 8

The system according to any one of supplements 1 to 7,
in which the work implement includes a bucket, and
the work reference point is any one of a left end, a center, and a right end of the bucket.

### Supplement 9

A method for controlling a work machine including a revolving body revolvable around a revolving center and a work implement attached to the revolving body, the method including:
acquiring a design line extending on a terrain on which construction is carried out;
determining a target line based on the design line; and
executing revolving alignment control for causing the revolving of the revolving body to automatically stop when a work reference point included in the work implement reaches the target line during the revolving of the revolving body.

### Supplement 10

The method according to supplement 9, including causing the work machine, the target line, and the work reference point to be displayed on a display.

### Supplement 11

The method according to supplement 9 or 10, including receiving an operation signal from an operation device operable by an operator to manually operate revolving of the revolving body; and
causing the revolving body to revolve in response to a manual operation of the operation device and causing revolving of the revolving body to automatically stop when the work reference point reaches the target line.

### Supplement 12

The method according to supplement 11, including causing the revolving body to revolve in response to a manual operation of the operation device after causing the revolving of the revolving body to automatically stop through the revolving alignment control, and disabling the automatic stop of the revolving body when the work reference point is located within a predetermined region.

### Supplement 13

The method according to supplement 12, in which the predetermined region is a range up to a position separated by an allowable width from the target line.

### Supplement 14

The method according to supplement 12 or 13, including causing the work machine, the target line, the work reference point, and the predetermined region to be displayed on a display.

### Supplement 15

The method according to supplement 14, further including:
causing the predetermined region to be displayed on the display when the work reference point is located within the predetermined region after causing the revolving of the revolving body to automatically stop through the revolving alignment control, and
erasing the predetermined region from the display when the work reference point is outside the predetermined region.

### Supplement 16

The method according to any one of supplements 9 to 15,
in which the work implement includes a bucket, and
the work reference point is any one of a left end, a center, and a right end of the bucket.

According to the present disclosure, in the work machine, a revolving operation for aligning the work implement is facilitated.

1. A system for controlling a work machine including a revolving body revolvable around a revolving center and a work implement attached to the revolving body, the system comprising:
a controller configured to
acquire a design line extending on a terrain on which construction is carried out;
determine a target line based on the design line; and
execute revolving alignment control to cause the revolving of the revolving body to automatically stop when a work reference point included in the work implement reaches the target line during the revolving of the revolving body.

2. The system according to claim 1, further comprising:
a display,
the controller being configured to cause the work machine, the target line, and the work reference point to be displayed on the display.

3. The system according to claim 1, further comprising:
an operation device operable by an operator to manually operate revolving of the revolving body,
the controller being configured to cause the revolving body to revolve in response to a manual operation of the operation device and cause revolving of the revolving body to automatically stop when the work reference point reaches the target line.

4. The system according to claim 3, wherein
the controller is configured to cause the revolving body to revolve in response to a manual operation of the operation device after causing the revolving of the revolving body to automatically stop through the revolving alignment control, and disable the automatic stop of the revolving body when the work reference point is located within a predetermined region.

5. The system according to claim 4, wherein
the predetermined region is a range up to a position separated by an allowable width from the target line.

6. The system according to claim 4, further comprising:
a display,
the controller being configured to cause the work machine, the target line, the work reference point, and the predetermined region to be displayed on the display.

7. The system according to claim 6, wherein
the controller is configured to
cause the predetermined region to be displayed on the display when the work reference point is located within the predetermined region after causing the revolving of the revolving body to automatically stop through the revolving alignment control, and
erase the predetermined region from the display when the work reference point is outside the predetermined region.

8. The system according to claim 1, wherein
the work implement includes a bucket, and
the work reference point is any one of a left end, a center, and a right end of the bucket.

9. A method for controlling a work machine including a revolving body revolvable around a revolving center and a work implement attached to the revolving body, the method comprising:
acquiring a design line extending on a terrain on which construction is carried out;
determining a target line based on the design line; and
executing revolving alignment control to cause the revolving of the revolving body to automatically stop when a work reference point included in the work implement reaches the target line during the revolving of the revolving body.

10. The method according to claim 9, further comprising:
causing the work machine, the target line, and the work reference point to be displayed on a display.

11. The method according to claim 9, further comprising:
receiving an operation signal from an operation device operable by an operator to manually operate revolving of the revolving body; and
causing the revolving body to revolve in response to a manual operation of the operation device and causing revolving of the revolving body to automatically stop when the work reference point reaches the target line.

12. The method according to claim 11, further comprising:
causing the revolving body to revolve in response to a manual operation of the operation device after causing the revolving of the revolving body to automatically stop through the revolving alignment control, and disabling the automatic stop of the revolving body when the work reference point is located within a predetermined region.

13. The method according to claim 12, wherein
the predetermined region is a range up to a position separated by an allowable width from the target line.

14. The method according to claim 12, further comprising:
causing the work machine, the target line, the work reference point, and the predetermined region to be displayed on a display.

15. The method according to claim 14, further comprising:
causing the predetermined region to be displayed on the display when the work reference point is located within the predetermined region after causing the revolving of the revolving body to automatically stop through the revolving alignment control, and
erasing the predetermined region from the display when the work reference point is outside the predetermined region.

16. The method according to claim 9, wherein
the work implement includes a bucket, and
the work reference point is any one of a left end, a center, and a right end of the bucket.
